(19) United States
(12) Patent Application Publication
(10) Pub. No.: US 2022/0361011 A1
(43) Pub. Date: Nov. 10, 2022

(54) MISMATCH DETECTION IN DIGITAL TWIN DATA BY COMPARING TO THRESHOLDS THE RELIABILITY AND LATENCY CONSTRAINT COMMUNICATION RELATED VALUES RECEIVED FROM SOURCES WITH GEOLOCATION INFORMATION

(71) Applicant: NOKIA SOLUTIONS AND NETWORKS OY, Espoo (FI)

(72) Inventors: Mikko Aleksi UUSITALO, Helsinki (FI); Kimmo Kalervo HÄTÖNEN, Helsinki (FI); Tero Johannes IHALAINEN, Nokia (FI); Dani Johannes KORPI, Helsinki (FI); Martti Johannes MOISIO, Klaukkala (FI)

(21) Appl. No.: 17/623,538

(22) PCT Filed: Jul. 1, 2019
(86) PCT No.: PCT/EP2019/067521

§ 371 Date: Dec. 28, 2021

(51) Int. Cl. H04W 24/04; H04W 24/08; H04W 24/02

(52) U.S. Cl. CPC H04W 24/04; H04W 24/08; H04W 24/02

(57) ABSTRACT

Systems, methods, apparatuses, and computer program products for detecting mismatch in digital twin data. One method may include receiving, by a radio network control system, at least one of reliability and latency constraint communication related values from one or more sources with geolocation information. The method may further include comparing the at least one of received reliability and latency constraint communication related values to one or more threshold values of the one or more sources to determine presence of a mismatch. The method may also include sending one or more indications of the comparison of the at least one of reliability and latency constraint communication related values and the one or more threshold values to a system element for determining a need for one or more actions.

### FIELD

Some example embodiments may generally relate to mobile or wireless telecommunication systems, or other communications systems. For example, certain embodiments may relate to apparatuses, systems, and/or methods for detecting mismatch in digital twin data and/or relating to that.

### BACKGROUND

Examples of mobile or wireless telecommunication systems may include the Universal Mobile Telecommunications System (UMTS) Terrestrial Radio Access Network (UTRAN), Long Term Evolution (LTE) Evolved UTRAN (E-UTRAN), LTE-Advanced (LTE-A), private LTE or 5G, MulteFire, LTE-A Pro, and/or fifth generation (5G) radio access technology or new radio (NR) access technology. Fifth generation (5G) wireless systems refer to the next generation (NG) of radio systems and network architecture. 5G is mostly built on a new radio (NR), but the 5G (or NG) network can also build on E-UTRAN radio. It is estimated that NR will provide bitrates on the order of 10-20 Gbit/s or higher, and will support at least enhanced mobile broadband (eMBB) and ultra-reliable low-latency-communication (URLLC) as well as massive machine type communication (mMTC). NR is expected to deliver extreme broadband and ultra-robust, low latency connectivity and massive networking to support the Internet of Things (IoT) in different verticals like home, transportation, smart cities, plants, factories, traffic, power industries. With IoT and machine-to-machine (M2M) communication becoming more widespread, there will be a growing need for networks that meet the needs of at least one of power, data rate, latency and battery life. It is noted that, in 5G, the nodes that can provide radio access functionality to a user equipment (i.e., similar to Node B in UTRAN or eNB in LTE) are named gNB when built on NR radio and named NG-eNB when built on E-UTRAN radio. When developing further radio technologies may evolve.

### SUMMARY

In accordance with some example embodiments, a method may include receiving, by a radio network control system, one or more reliability and latency constraint communication related values from one or more sources with geolocation information. The method may further include comparing the one or more received reliability and latency constraint communication related values to one or more threshold values of the one or more sources to determine presence of a mismatch. The method may also include sending one or more indications of the comparison of the reliability and latency constraint communication related values and the one or more threshold values to a system element for determining a need for one or more actions.

In accordance with some example embodiments, an apparatus may include means for receiving, by a radio network control system, one or more reliability and latency constraint communication related values from one or more sources with geolocation information. The apparatus may further include means for comparing the one or more received reliability and latency constraint communication related values to one or more threshold values of the one or more sources to determine presence of a mismatch. The apparatus may also include means for sending one or more indications of the comparison of the reliability and latency constraint communication related values and the one or more threshold values to a system element for determining a need for one or more actions.

In accordance with some example embodiments, an apparatus may include at least one processor and at least one memory including computer program code. The at least one memory and the computer program code may be configured to, with the at least one processor, cause the apparatus at least to receive, by a radio network control system, one or more reliability and latency constraint communication related values from one or more sources with geolocation information. The apparatus may further be caused to compare the one or more received reliability and latency constraint communication related values to one or more threshold values of the one or more sources to determine presence of a mismatch. The apparatus may also be caused to send one or more indications of the comparison of the reliability and latency constraint communication related values and the one or more threshold values to a system element for determining a need for one or more actions.

In accordance with some example embodiments, a non-transitory computer readable medium can be encoded with instructions that may, when executed in hardware, perform a method. The method may receive, by a radio network control system, one or more reliability and latency constraint communication related values from one or more sources with geolocation information. The method may further compare the one or more received reliability and latency constraint communication related values to one or more threshold values of the one or more sources to determine presence of a mismatch. The method may also send one or more indications of the comparison of the reliability and latency constraint communication related values and the one or more threshold values to a system element for determining a need for one or more actions.

In accordance with some example embodiments, a computer program product may perform a method. The method may receive, by a radio network control system, one or more reliability and latency constraint communication related values from one or more sources with geolocation information. The method may further compare the one or more received reliability and latency constraint communication related values to one or more threshold values of the one or more sources to determine presence of a mismatch. The method may also send one or more indications of the comparison of the reliability and latency constraint communication related values and the one or more threshold values to a system element for determining a need for one or more actions.

In accordance with some example embodiments, an apparatus may include circuitry configured to receive, by a radio network control system, one or more reliability and latency constraint communication related values from one or more sources with geolocation information. The apparatus may further include circuitry configured to compare the one or more received reliability and latency constraint communication related values to one or more threshold values of the one or more sources to determine presence of a mismatch. The apparatus may also include circuitry configured to send one or more indications of the comparison of the reliability and latency constraint communication related values and the one or more threshold values to a system element for determining a need for one or more actions.

In accordance with some example embodiments, a method may include receiving, by a service management portal, one or more indications of comparisons of one or more received reliability and latency constraint communication related values with geolocation information to one or more threshold values of one or more sources. The method may also include determining a need for one or more actions based on the one or more indications. The method may further include in response to the determination, triggering one or more acting elements to perform a specific action at a location corresponding to the geolocation information to optimize radio performance at the location.

In accordance with some example embodiments, an apparatus may include means for receiving, by a service management portal, one or more indications of comparisons of one or more received reliability and latency constraint communication related values with geolocation information to one or more threshold values of one or more sources. The apparatus may also include means for determining a need for one or more actions based on the one or more indications. The apparatus may further include means for, in response to the determination, triggering one or more acting elements to perform a specific action at a location corresponding to the geolocation information to optimize radio performance at the location.

In accordance with some example embodiments, an apparatus may include at least one processor and at least one memory including computer program code. The at least one memory and the computer program code may be configured to, with the at least one processor, cause the apparatus at least to receive, by a service management portal, one or more indications of comparisons of one or more received reliability and latency constraint communication related values with geolocation information to one or more threshold values of one or more sources. The apparatus may also be caused to determine a need for one or more actions based on the one or more indications. The apparatus may further be caused to, in response to the determination, trigger one or more acting elements to perform a specific action at a location corresponding to the geolocation information to optimize radio performance at the location.

In accordance with some example embodiments, a non-transitory computer readable medium can be encoded with instructions that may, when executed in hardware, perform a method. The method may receive, by a service management portal, one or more indications of comparisons of one or more received reliability and latency constraint communication related values with geolocation information to one or more threshold values of one or more sources. The method may also determine a need for one or more actions based on the one or more indications. The method may further, in response to the determination, trigger one or more acting elements to perform a specific action at a location corresponding to the geolocation information to optimize radio performance at the location.

In accordance with some example embodiments, a computer program product may perform a method. The method may receive, by a service management portal, one or more indications of comparisons of one or more received reliability and latency constraint communication related values with geolocation information to one or more threshold values of one or more sources. The method may also determine a need for one or more actions based on the one or more indications. The method may further, in response to the determination, trigger one or more acting elements to perform a specific action at a location corresponding to the geolocation information to optimize radio performance at the location.

In accordance with some embodiments, an apparatus may include circuitry configured to receive, by a service management portal, one or more indications of comparisons of one or more received reliability and latency constraint communication related values with geo location information to one or more threshold values of one or more sources. The apparatus may also include circuitry configured to determine a need for one or more actions based on the one or more indications. The apparatus may further include circuitry configured to, in response to the determination, trigger one or more acting elements to perform a specific action at a location corresponding to the geolocation information to optimize radio performance at the location.

An apparatus, comprising at least one memory comprising computer program code, the at least one memory and computer program code configured, with the at least one processor, to cause the apparatus at least to receive, by a mobile device from a service management portal, a trigger to perform one or more actions at a location corresponding to a geolocation information to optimize radio performance at the location, wherein the one or more actions are based on a determination of a need from one or more indications received from at least one comparison of at least one of received reliability and latency constraint communication related values with the geolocation information to one or more threshold values of one or more sources. The apparatus may be a drone or embedded in a drone.

### BRIEF DESCRIPTION OF THE DRAWINGS

For proper understanding of example embodiments, reference should be made to the accompanying drawings, wherein:

FIG. 1 illustrates a problem framework on applying ultra-reliable low latency communication (URLLC) in a harbor that experiences blocking and interference.

FIG. 2 illustrates another problem framework on applying URLLC in a harbor environment and having radio interference.

FIG. 3 illustrates a flowchart of an operational loop, according to an example embodiment.

FIG. 4 illustrates a combination model solution, according to an example embodiment.

FIG. 5 illustrates implementing drones in a harbor environment, according to an example embodiment.

FIG. 6(a) illustrates a physical model of a radio map, according to an example embodiment.

FIG. 6(b) illustrates a flow diagram for estimating reliability values, according to an example embodiment.

FIG. 7 illustrates a signaling flow, according to an example embodiment.

FIG. 8 illustrates a radio-based procedure for updating the digital twin, according to an example embodiment.

FIG. 9 illustrates a procedure for communicating with a digital twin, according to an example embodiment.

FIG. 10 illustrates a radio environment map, according to an example embodiment.

FIG. 11 illustrates requirements for service, according to an example embodiment.

FIG. 12 illustrates a signalling flow, according to an example embodiment.

FIG. 13 illustrates a network system implementing the signal flow illustrated in FIG. 12.

FIG. 14 illustrates a flow diagram of a method, according to an example embodiment.

FIG. 15 illustrates a flow diagram of another method, according to an example embodiment.

FIG. 16(a) illustrates an example apparatus, according to an example embodiment.

FIG. 16(b) illustrates an example of another apparatus, according to an example embodiment.

### DETAILED DESCRIPTION

It will be readily understood that the components of certain example embodiments, as generally described and illustrated in the figures herein, may be arranged and designed in a wide variety of different configurations. In addition, the following detailed description represents some example embodiments of systems, methods, apparatuses, and computer program products for detecting mismatch in digital twin data.

The features, structures, or characteristics of example embodiments described throughout this specification may be combined in any suitable manner in one or more example embodiments. For example, the usage of the phrases “certain embodiments,” “an example embodiment,” “some embodiments,” or other similar language, throughout this specification refers to the fact that a particular feature, structure, or characteristic described in connection with an embodiment may be included in at least one embodiment. Thus, appearances of the phrases “in certain embodiments,” “an example embodiment,” “in some embodiments,” “in other embodiments,” or other similar language, throughout this specification do not necessarily all refer to the same group of embodiments, and the described features, structures, or characteristics may be combined in any suitable manner in one or more example embodiments.

Additionally, if desired, the different functions or steps discussed below may be performed in a different order and/or concurrently with each other. Furthermore, if desired, one or more of the described functions or steps may be optional or may be combined. As such, the following description should be considered as merely illustrative of the principles and teachings of certain example embodiments, and not in limitation thereof. Regarding one or more received reliability and latency constraint communication related values with the geolocation information to one or more threshold values of one or more sources in one embodiment one of reliability and latency constraint communication related values can be used.

5G is expected to have multiple radio interfaces, namely below 6 GHz, cmWave and mmWave, and also being integradable with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 6 GHz-cmWave, below 6 GHz-cmWave-mmWave). One of the concepts considered to be used in 5G networks is network slicing in which multiple independent and dedicated virtual sub-networks (network instances) may be created within the same infrastructure to run services that have different requirements on latency, reliability, throughput and mobility.

The current architecture in LTE networks is fully distributed in the radio and fully centralized in the core network. The low latency applications and services in 5G require bringing the content close to the radio, which leads to local breakout and multi-access edge computing (MEC). 5G enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers or devices for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), and critical communications (autonomous vehicles, traffic safety, real-time analytics, time-critical control, healthcare applications).

Ultra-reliable low latency communication (URLLC) is a research topic in 3^{rd} Generation Partnership Project (3GPP) new radio (NR, 5G) work, described in 3GPP TR 38.913 V14.1.0. In URLLC service, the packets have to be delivered within certain tight latency requirements (e.g., 1 ms) with very high reliability (e.g., with 0.99999 success probability).

Furthermore, URLLC payload may carry critical messages including, for example, messages related to industrial control, V2X/V2V communication, and others. The failure of these messages may result in critical errors in the system operation, which may in turn cause considerable financial damage. Moreover, in certain cases, malfunction may compromise human safety.

There has been ongoing research and standardization activities to develop solutions to reach the desired reliability within the given delay budget. Solutions may include issues such as high-order diversity order, extremely robust channel codes (e.g., Polar codes), multi-connectivity, dedicated spectrum, and more. In addition, cellular operation with unmanned aerial vehicles (UAV, e.g., drones) has been under active research and under standardization.

Digital twins may be of interest in maintaining in digital form, a copy of the physical environment in order to be better able to control actions in the physical environment. A digital twin may comprise a digital replica of a living or non-living physical entity. Digital twin may refer to a digital replica of physical assets (physical twin), processes, people, places, systems and devices that can be used for various purposes. The digital twin may have a connection between the physical model and the corresponding virtual model or virtual counterpart. The connection may be established by generating real time data using or received from sensors. In the example of the embodiment data of digital twin is analyzed and if some data is missing an alert message may be generated. A digital twin may learn and update itself from multiple sources of physical assets to represent its near real-time status, working condition or position. Furthermore, the connection may be arranged between the tracked objects and the digital twin and also with operating systems in different business verticals like harbor, transportation, health, etc. A digital twin may be created and maintained by software-based tools. Furthermore, radio maps may be created and the data from radio maps may be linked or coupled to digital twin and further to operating systems for control and maintain the product and connectivity information like power, data rate, latency and battery life for example of different vertical industry needs.

In view of the importance of digital twins, several factors have now converged to bring the concept of the digital twin to the forefront as a trend that may have an increasingly broad and deep impact on the future. In particular, half of large industrial companies may use digital twins, resulting in those organizations gaining an improvement in effectiveness. Digital twins may drive the business impact of the Internet of Things (IoT) by offering a powerful way to monitor and control assets and processes.

In an environment requiring URLLC, there may be continuous changes, which may make it challenging to maintain a certain URLLC-level reliability. For instance, in a harbor environment, containers are often moved in and out, which changes the radio propagation conditions in that particular environment. This, on the other hand, may increase the risk that the URLLC requirements might not be fulfilled in the areas with insufficient signal quality. Similarly, the digital twin information may not always be up-to-date either due to lack of having a perfect control and information update or due to surprising changes in the environment.

There have been certain challenges in creating some database or other data storage system that contains updated relevant information. This is often the case with digital twins. In one example, problems may arise in the case of a harbor environment where interference and blocking may be caused by physical objects.

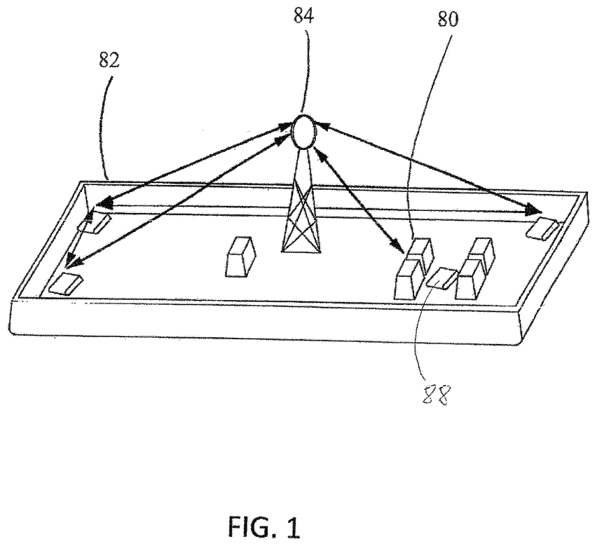

FIG. 1 illustrates a problem framework on applying URLLC in a harbor that experiences blocking and interference, signal between the base station 84 and autonomous vehicle is blocked by the container or piles of containers 80, for example. In a harbor area 82, autonomous vehicles 88 may be handling incoming and outgoing cargo (e.g., containers) 80. The autonomous vehicles, when moving, may need to have a continuous connection to a control unit and other vehicles using URLLC radio. In such an environment, the borders of the area may be defined by the borders of the harbor. In addition, the physical layout inside the harbor area may always be changing as containers 80 or piles of containers 80 come and go.

In the harbor, the containers may be impenetrable for radio waves and may cause a set of reflections that interfere with other transmissions. Thus, if an autonomous vehicle is left without a radio connection, it has to stop for safety reasons. As such, there is a problem where the autonomous vehicle may not be able to know where blind spots are, which would cause the vehicle to stop. There is also a challenge of being able to predict and notice the autonomous vehicle's appearance, changes in the vehicle, and prevent or resolve issues as soon as possible.

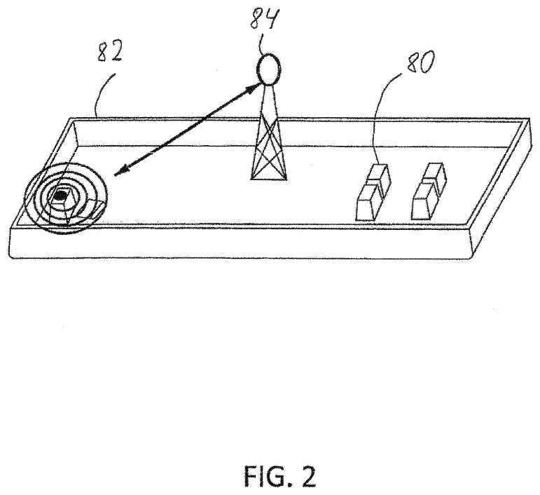

FIG. 2 illustrates another problem framework on applying URLLC in a harbor environment and having radio interference. As illustrated in FIG. 2, the URLLC area in the harbor environment may experience cases of radio interference. Another source for disturbances in URLLC coverage may be broken or misplaced radio or electrical equipments. The problem is to be able to know where the distributed blind spots are that cause vehicles to stop, and to be able to notice their appearance, changes in the vehicles, and prevent or resolve them as soon as possible. In an example embodiment, the appearance may refer to situations where blind spots (e.g., from the URLLC radio connectivity point of view) are created in certain parts of the automated harbor operation area. The blind spots may be created because of changes in the physical layout of the harbor due to, for example, piling of shipping containers creating blockers with respect to access point(s). In addition, cargo-handling equipment may change the appearance. For example, a crane may raise or lower its height, and other devices may lift, raise or move some cargo handling arms.

According to certain example embodiments, for reliable radio operation, a means for having updated and accurate information on the radio environment may be provided. Such information may be stored in a digital radio twin, especially if the digital radio twin is up to date. Additionally, certain example embodiments may detect mismatches between a digital twin and a real-world environment. For instance, in certain example embodiments, it may be possible to compare real world radio parameters (e.g., URLLC latency) and the parameters calculated based on the digital twin (the latter may be obtained with machine learning (ML)).

In certain example embodiments, if there is a larger mismatch than a predefined threshold, it may indicate that the digital twin is outdated and drones or other equipment may be sent to update the digital twin. In addition, a high URLLC latency without any mismatch may trigger the drones as it may be important to have a more accurate digital twin in the critical areas. Moreover, prediction may be done without measurements, based on the model and ML. In an example embodiment, the model may refer to an ML-based neural network model, which may be pre-trained to enable prediction of radio performance (e.g., in terms of reliability metric) in a desired part(s) of the harbor based on information included in the digital twin.

For example, the ML algorithm may be designed to observe radio measurements in a physical area and predict some key performance metric based on these measurements. For obtaining the input data, the whole area may be divided into a uniform grid, and the measurements may be associated to the grid point at which they have been obtained. By feeding N-by-N tensor of the adjacent grid points into the ML algorithm, it may make the prediction based on the data.

According to certain example embodiments, it may be possible to secure the constantly, periodically, or on needed base, updated existence of accurate digital radio twin via sending drones or other moving measurement platforms to carry out signal measurements. This may be done to carry out signal measurements to one or more locations having had known changes in their setup in order to detect potential mismatches with the digital twin or other model of the environment in question (e.g., a harbor). The changes in their setup may refer to changes in the physical layout of the automated harbor (e.g., due to shipping containers moved in and out, changed locations of big cranes, potentially creating blockage) and/or in the configuration of supporting radio network elements (e.g., new gNBs/TRPs, changes in orientation of the antenna arrays, etc.). Signal measurements may also be carried out to carry out constant patrolling to obtain measurements everywhere in the area requiring URLLC. According to certain example embodiments, patrolling routes may be defined based on measurements and the model with the highest amount of patrolling in areas with much of the action in the port and in areas with more challenging radio conditions (i.e., longest latencies).

In an example embodiment, constant patrolling may be done to detect any similar mismatches (even though there may have been no changes known by the central control unit controlling the environment). Furthermore, the signal measurements may be carried out to investigate more closely the areas where poor or unexpected radio performance is observed. This may be accomplished by monitoring the spatial URLLC reliability as well as by comparing the observed reliability to the reliability predicted based on the digital twin.

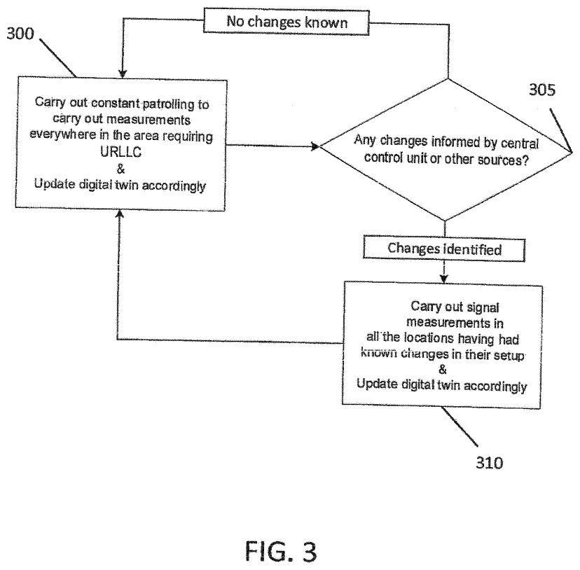

FIG. 3 illustrates a flowchart of an operational loop, according to an example embodiment. At 300 of the operational loop, the drones or other moving measurement platforms may carry out periodic patrolling when needed. According to certain example embodiments, the periodicity of patrolling may depend on the anticipated rate of changes in the corresponding part of the digital twin. In an example embodiment, for the overall efficiency of operation, areas with high-levels of harbor operation activity may be prioritized over other areas for which there is no need to provide URLLC connectivity at a given time. According to an example embodiment, patrolling on these lower-priority sub-areas may be triggered based on information in the central control unit on forthcoming harbor operation in those areas.

The patrolling may be performed to carry out measurements everywhere in the area requiring URLLC, and to update, by the central control unit, the corresponding digital twin of the environment accordingly. In an example embodiment, the updates may include drone or other mobile measurement platform-based updates to 1) physical 3D layout model of the harbor (including information, e.g., on the type of objects detected and identified, their locations etc.), and 2) different metrics of the 3D radio environment map (e.g., SNR/SINR, BLER, etc.).

In an embodiment, the patrolling may be started in certain times including, for example, in case of moving of loader or crane, loading and/or movement of cargo. At 305, the central control unit may receive the measurements obtained by the drones or other moving platforms to determine if there are any signal changes between the real environment and the corresponding digital twin. If there are no changes, then the procedure reverts back to 300. However, if changes have been identified, at 310, the drones or other moving measurement platforms may carry out signal measurements in one or more locations having had known changes in their setup, and update the digital twin accordingly with the new signal measurements at the locations having had known changes in their setup. After carrying out the signal measurements and updating the digital twin at 310, the procedure may return to 300.

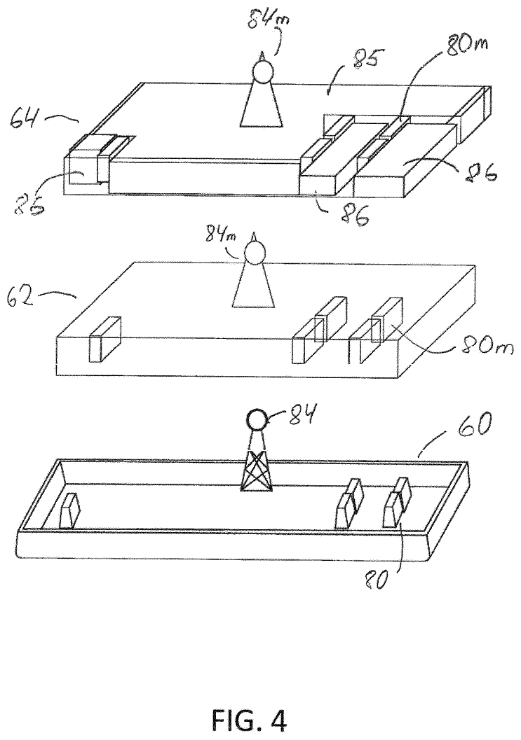

FIG. 4 illustrates a combination model solution, according to an example embodiment. As illustrated in FIG. 4, a solution related to a digital twin of a physical layout of a harbor environment is provided. The solution may be based on a combination of several models. According to an example embodiment, the models may include a physical 3D layout of the harbor area 60 (e.g., cargo containers 80, devices/machines and radio network elements 84 for example) in lower part of FIG. 4, a current 3D model of the physical layout of the harbor operation area 62 (e.g., object models of radio network elements 84m and cargo containers 80m for example) in the middle part of the FIG. 4, and radio map 64 of the area with coverage information 85 (covered) and 86 (not covered or difficulties in coverage) in the top part of the FIG. 4. The coverage information comprises radio coverage value based on the radio performance, for example in the layout view. The knowledge and ML based predictions may correspond to predictions on how changes in the layout will affect the radio map, and how changes in the radio map will affect performance of harbor functions.

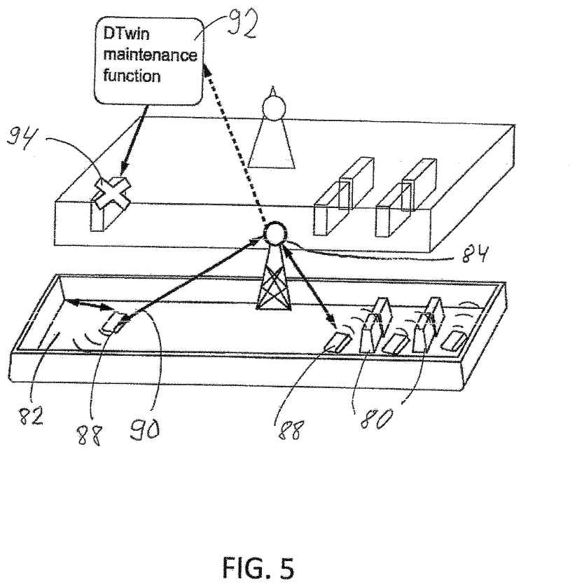

FIG. 5 illustrates implementing drones in a harbor environment, according to an example embodiment. The bottom part of FIG. 5 represents a snapshot of the real-world harbor operation area 82 at a given time according to one embodiment. A base station 84, two piles of shipping containers 80 and a set of mobile devices (e.g. UAVs) 88 measuring/sensing the harbor area 82 modelled by the digital twin area shown. The pointing arrows represent radio communication links 90 between the mobile devices 88 and a base station 84, or illustrating location measurement of the mobile device to the border of the harbor area, or other object, for example. Those links are utilized for example for command and control channel to/from measuring(sensing) mobile devices 88 or uplink data channel to transfer sensor data from measuring(sensing) mobile devices 88. The top part of FIG. 5 represents a snapshot of the model of the physical layout of the harbor operation area 82 at a given time, which is maintained as part of the digital twin according to one embodiment. For example, the dashed line between the base station 84 and the DTwin maintenance function 92 of the digital twin represents transfer of the physical layout measurement data, and the cr showing location measurement related to the border of the harbor oss-marker 94 on top of a shipping container(s) 80 in the bottom-left corner of the top part of FIG. 5, shows an identified mismatch in the model of the physical layout of the harbor area 82 in the digital twin (as result of removed shipping containers). Thus, digital twin may be updated.

As illustrated in FIG. 5, mobile devices 88 may provide the needed updated information to create and maintain digital twin models by sending the sensor data to the digital twin. According to certain example embodiments, the mobile devices 88 used may include autonomously, semi-autonomously or other ways steerable moving or movable sensors measuring parameters in the physical world. The drones as mobile devices in one example embodiment may be able to position themselves, whereas in another example embodiment, the control system may be able to position the drones. As illustrated in FIG. 5, the mobile devices 88 may measure their surroundings and report the findings to the digital twin maintenance function. In one embodiment the mobile devices 88 may have proximity sensors which may provide information of the objects in proximity. The information may be sent to digital twin over interface or through digital twin maintenance function or functionality. With the findings, the digital twin DTwin maintenance function may update the measured model, for example, the physical layout or radio map and respective data of the objects, for example.

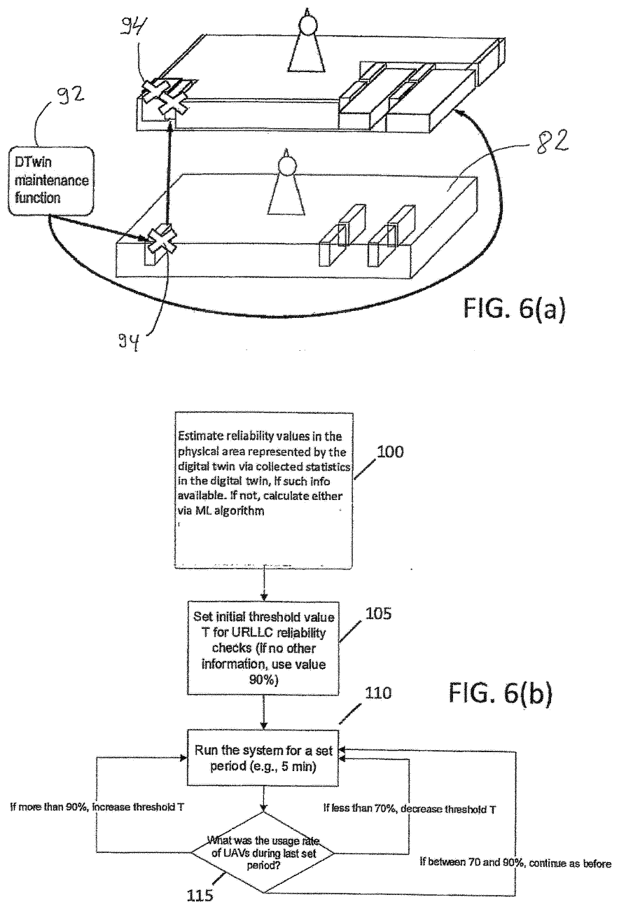

FIG. 6(a) illustrates the role/operation of the DTwin maintenance function 92, according to an example embodiment. As illustrated in FIG. 6(a), changes in the DTwin model of the physical layout may be reflected in a radio map. Furthermore, in an example embodiment, changes may be reflected to maintenance of vehicle routes and operations. In addition, according to another example embodiment, drones may measure radio environments directly. The FIG. 6(a) represents a snapshot of the DTwin maintenance function of the digital twin according to one embodiment. As a result of the mismatch identification the model of the physical layout and/or values of objects (for example location coordinates from GPS) in the digital twin is updated to reflect the new measurement/sensor data. The top part of the FIG. 6(a) can be considered to represent an estimated (in one embodiment based on ML-based prediction for example) level of radio performance (for example, from the URLLC data, including critical metric(s) perspective) at different parts (locations) of the harbor operation area 82. The cross-markers 94 in the bottom-left corner of the top of FIG. 6(a) illustrates how updating the digital twin based on identified mismatches may impact also the radio environment maps maintained as part of the digital twin. The cross-marker 94 on the container represents that the container may be deleted or the cross-marker 94 beside the container may represent that the non-coverage may have changed to radio coverage area. Here in the shown example case, e.g., estimated/predicted reliability in the bottom left corner in the top of FIG. 6(a) is expected to improve as a result of one or more removed previously-blocking shipping containers.

More sensors are being installed into devices of harbor operators. For example, cargo handling equipment may be equipped to have light detection and ranging (LIDAR) so that they may more accurately and more autonomously carry out the cargo handling (e.g., grabbing a container or leaving a container at a right place). Instead of drones, such moving cargo handling equipment may also use LIDAR in the harbor, and may have the scanning on with the LIDAR radar.

For wireless communications over high capacity 5G, information on line-of-sight (LOS) or non-line-of-sight (NLOS) conditions is important for the reliability of the operation. Reliability may directly impact the quality of the autonomous operation including, for example, creating an autonomous harbor.

According to certain example embodiments, the central control unit for a certain area or environment, such as, for example, a harbor, may know any changes in the area under its control. During and after such changes the measurement equipment (or drone or other vehicle) may be sent to that area. Such a change may be for example, a result of moving a container or containers, or transferring any object as controlled by the central control unit. However, unexpected events may occur, and, thus, constant additional patrolling by the measurement equipment may be performed. For example, in a real-life harbor environment, sometimes individual truck drivers may bring in or remove some containers without being properly linked to the digital system of the harbor. In such situations, drones may be used for periodic patrolling. According to an example embodiment, patrolling may be defined based on measurements and the model—with the highest amount of patrolling in areas with much of the action in the port and in areas with more challenging radio conditions, such as longest latencies.

In certain example embodiments, unexpected or poor radio performance may be used to trigger the deployment of drones to carry out more detailed measurements in the corresponding area. Furthermore, a high URLLC latency without any mismatch between actual measured radio performance at an area and the corresponding digital twin may trigger the drones since it may be important to have a more accurate digital twin in the critical areas. In certain example embodiments, the mismatch may refer to a difference in modeled and measured parameters that is higher than some threshold. The threshold, according to an example embodiment, may be defined by the use case, such as the maximum latency to maintain the reliability at a level required by the automation.

In addition, according to an example embodiment, prediction may be performed without measurements, and instead be based on the model and ML. According to an example embodiment, the model may correspond to an ML-based neural network model, which may be pre-trained to enable prediction of radio performance (e.g., in terms of reliability metric) in desired part(s) of the harbor based on information included in the digital twin. In another example embodiment, a trigger or action to be done may be illustrated on the display of the system to enable the operator to control and/or start needed action(s). Furthermore, poor radio communication may take place between any devices communicating over radio. As such, it may be important to detect poor radio communication for devices needing URLLC, for example, such as for autonomous cargo handling equipment and one or more base stations (BSs) to which it is connected. Further if managed by centrally controlled operating system by operator the need of speed and reliability may be controlled also between base station and centrally controlled operating system.

According to certain example embodiments, any unexpected behavior may be detected by predicting the expected radio performance from the digital twin and potential complementary measurements using an ML algorithm. In an example embodiment, the digital twin may be classified as being outdated when there is a large enough mismatch between the predicted and observed behavior of the radio system. For example, as previously noted, when comparing the real radio parameters (e.g., URLLC latency) and the radio parameters calculated based on the digital twin, if there is a larger mismatch than a predefined threshold, the digital twin may be classified as being outdated. When this occurs, drones or other equipment may be sent to update the digital twin. In order to rectify the mismatch, a base station may be added to the affected area so that latency requirements may be reached.

In an example embodiment, poor radio performance may indicate that the radio system is operating close to its limit in the corresponding location, and the digital twin should be especially accurate in that area. Otherwise, the digital twin may not be useful for any type of radio system optimization due to the low margins of error needed. In an example embodiment, poor radio performance may be detected based on the feedback provided by UEs and the BSs.

According to certain example embodiments, prior to detecting mismatches between the digital twin and the real world environment, certain preparatory steps may be needed. For example, one step may include collecting information on the real-life physical area or environment where equipment (e.g., containers, cranes, ships, and other objects) is controlled. Another step may include formulating a model out of the information on the physical environment. This may be a database with the physical dimensions of the environment and objects in that environment.

A further preparatory step may include measuring the environment with a drone or similar type measurement device. Another step may include making a model of the radio environment based on the physical environment model. According to an example embodiment, these models may include the physical dimensions and material properties of the environment to be analyzed as well as information on the radio wave propagation.

A further preparatory step may include learning the relationship between the physical and radio models using ML, and constructing the digital twin model based on the resulting radio and physical environments. The digital twin model, according to an example embodiment, may reflect the physical and real radio environments.

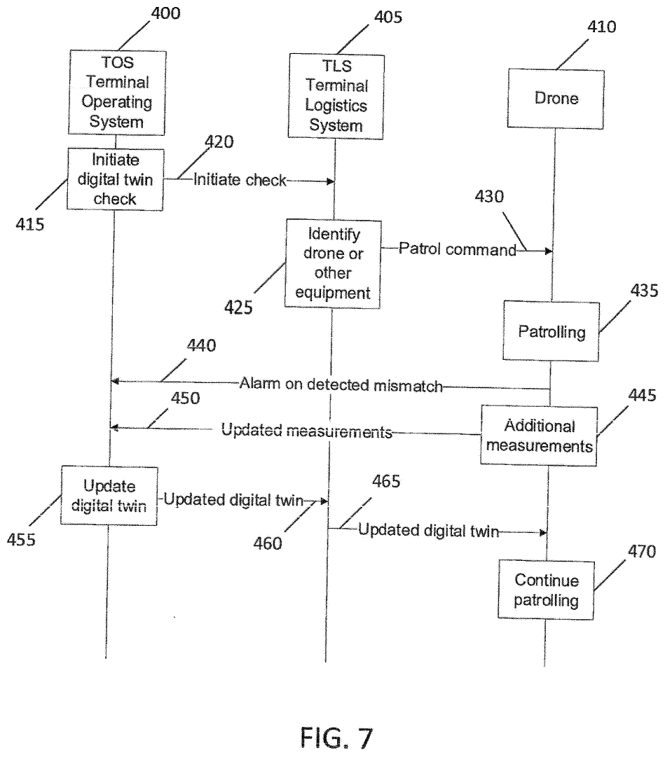

In an example embodiment, to secure the repeatedly updated existence of accurate radio twin, drones or other moving measurement platforms may be sent to carry out signal measurements. According to an example, embodiment, a terminal logistics system (TLS) such as that illustrated in FIG. 7 may send the drones. As previously noted, the signal measurements may be carried out to all the locations having had known changes in their setup, in order to detect potential mismatches with the digital twin or other model of the environment in question (e.g., a harbor). In addition, the signal measurements may be carried out to carry out repeated patrolling to obtain measurements everywhere in the area requiring URLLC. For example, this may include all areas with remote controlled equipment in order to detect any similar mismatches even though there may have been no changes known by the central control unit controlling the environment. In addition, according to an example embodiment, the signal measurements may be carried out to investigate areas where poor or unexpected radio performance is observed by monitoring for example periodically, in the desired frequency or constantly monitoring the spatial URLLC reliability.

In an example embodiment, the monitoring may include areas with latencies nearer a limiting threshold than in, for example, 90% of the areas. However, the percentage of the areas may differ in other example embodiments and/or may vary based on different needs and use cases. In addition, the 90% may represent a parameter that may be set for the system in any desired way. According to an example embodiment, this value may represent the amount of areas that are desired to be put under additional surveillance, where the remaining 10% may require additional checking effort. In other example embodiments, the signal measurements may be carried out to investigate areas where poor or unexpected radio performance is observed by comparing the observed reliability to the reliability predicted based on the digital twin.

According to certain example embodiments, reliability may be calculated. For instance, reliability on area A may be represented by (total_number_of_packets received correctly below latency constraints/total_number_of_packets), where 99.999% ( 1/100k can miss the target). In another example embodiment, reliability estimates may be estimated by the digital twin by for example, the help of system simulations in the digital twin and machine learning. Reliability estimates may also be estimated by sending a drone and measuring radio network conditions including, for example, signal-to-interference-plus-noise ratio (SINR) distribution, which may be mapped to the reliability estimate. According to a further example embodiment.

FIG. 6(b) illustrates a flow diagram for estimating reliability values, according to an example embodiment. For example, at 100, reliability values may be estimated in the physical area represented by the digital twin via collected statistics in the digital twin, if such information is available. If such information is not available, then, the estimated reliability values may be calculated via an ML algorithm or simulation. At 105, an initial threshold value T may be set for URLLC reliability checks. However, if no other information is available a value of 90% may be used as T. At 110, the system may be run for a set period such as, for example, 5 minutes. After running the system, at 115, a determination of the usage rate of UAVs during the last set period may be made. If the usage rate was more than 90%, then the threshold value T may be increased. However, if the usage rate was less than 70%, then the threshold T may be decreased. In addition, if the usage rate was between 70% and 90%, then the procedure may be continued as before.

In an example embodiment, the parameters included in the model may depend on what is relevant for the digital twin. For example, for an automated harbor URLLC, the latency may be relevant. As such, in certain example embodiments, minimum parameters may be physical dimensions of the environment, objects and their material properties, as well as all the parameters needed for estimating URLLC. In the case of a digital twin of a harbor, enabling industrial harbor automation may require information including N-dimensional (3D+radio propagation+visual+audio, . . . ) model of a physical (physical model) environment that includes documentation of measured and estimated effects to radio transmission. For example, the documentation of measured and estimated effects to radio transmission may include factors such as LOS vs NLOS, reflecting surfaces, insulating objects, blocking objects, amount of light or voice, or volume of radio noise. LOS and NLOS may vary due to routes of the traffic and piles of containers.

In an example embodiment, if needed, the model may be separated into a 3D model, radio model, light model, temperature model and audio model, all of which may be different dimensions of physical surroundings. The information for enabling industrial harbor automation may also include an ML model about how changes in the physical world affects radio properties within the data twin model, and a component communicating with the drones and interpreting measurements sent by the drones. In an example embodiment, the component may correspond to the central control unit such as, for example in a terminal logistics system (TLS) under the control of a terminal operating system (TOS). The information may also include that regarding a component updating the physical model based on the drone input. In an example embodiment, the component may be able to detect mismatches and highlight those that may cause effects to the radio environment based on pre-defined knowledge or a learned model.

According to an example embodiment, the information may further include component detecting changes in the physical model and how their anticipated effects in radio environments affects to the performance of the production process in the area (e.g., factory, mine, harbor, shopping center, etc.). In a further example embodiment, the information may include the component managing and controlling the drone fleet.

In certain example embodiments, parameters that are particular to an automated harbor with URLLC may include dimensions and locations of identifiable cargo containers, dimensions and locations of cargo handling equipment, and dimensions and locations and types of other equipment in the harbor area. Additional parameters may include signal-to-interference-plus-noise ratio (SINR) and signal-to-noise ratio (SNR) of four or more nearest access points in all positions where the remote-controlled machinery needs to move to. Further, the parameters may include location-dependent map of the observed radio link quality (including, for example, performance metrics relevant for URLLC communication such as a block error rate (BLER) and latency).

According to certain example embodiments, the drone may be sent to the location which may be calculated to receive sufficient data rate for communication. In an example embodiment, this may be used as a waypoint or destination. Further, the drone may be expected to be sent to the location when there is a need to have the connection to be an appropriate speed (e.g., when the lift, truck, tractor, or crane is approaching to move the container). In an example embodiment, the drone route, one or more waypoints, or destination may be changed after the drone has approached the intended location. For example, the change may occur if the data rate of the communication is not sufficient, or a data rate is too low, or a source is missing yet in the intended location. Purpose is to get the missing source to work again and back to the digital twin.

In an example embodiment, location and position information may be obtained via several means. For example, the information may be obtained using any available location and positioning information including, for example, global positioning system (GPS), global navigation satellite system (GNSS), or other global positioning services. The information may also be obtained via stereo vision-based object detection and tracking from supporting drones that enable obtaining information on the sizes/dimension of different objects of interest. Further, the information may be obtained via laser-based distance measurements from assisting drone and/or cranes (with high accuracy positioning information). In addition, depending on the computation complexity and power consumption constraints of the assisting drones, LIDAR sensors mounted on the patrolling drones may be utilized to build and maintain a point cloud model of the area of interest with appropriate resolution in space.

Furthermore, the information may be obtained via cargo handling equipment, which may have LIDARs so that they may use the LIDARs for checks. In addition, the information may be obtained via the acquired dimension and location data, which may be used to build real-time situational awareness (e.g., in the form of LOS/NLOS link existence between target objects and the serving infrastructure).

According to certain example embodiments, instead of drones, the measurement devices may be mobile via other means such as for example, flying, swimming, driving, diving, walking, running, jumping, crawling, and creeping. In an example embodiment, each drone may carry out one or more tasks. One task may include, for example, measuring its surroundings for placement of physical objects that may be detected by reflections on some wavelength of light, sound or radio, or some other physical magnitude. Another task may include classifying objects based on their materials, shapes, and colors (i.e., information derived from measured reflections). In addition, the task may include classifying objects based on the attached tags, either visual or acoustic or radio, or that may be scanned and interpreted against a known sign system. Further, the task may include measuring over radio spectrum and identifying radio activity on different radio wavelengths. Moreover, the task may include identifying positions of radio transmitters.

FIG. 7 illustrates a signaling flow, according to an example embodiment. In particular, FIG. 7 illustrates an example of needed signaling for a harbor terminal. In FIG. 7, the terminal operating system (TOS) 400 may represent the central controlling unit, and may give commands to the radio network control system. In addition, the terminal logistics system (TLS) 405 may manage the movement of equipment in the harbor terminal. Further, TOS 400 and TLS 405 may be in communication with a drone 410.

In an example embodiment, when the central control unit notices a mismatch in the sensor data (coming from the drone or a cargo handling equipment, etc.) and the digital twin, an alarm may be made, and the drone may be instructed to stay in the area to sense more and find all the mismatches. The drone may also assist to facilitate the updating of the digital twin. The operation of the drone (or other equipment) may then continue to operate as before the alarm.

As illustrated in FIG. 7, at 415, TOS 400 may initiate a digital twin check, and send an initiation check message 420 to TLS 405. After receiving the initiation check message 420 from TOS 400, TLS 405 may identify, at 425, a drone or other equipment to perform the check. Once a drone has been identified, TLS 405 may send a patrol command 430 to drone 410, thereby instructing drone 410 to patrol a designate area within the physical environment (e.g., harbor) at 435. After performing the patrol, drone 410 may send an alarm 440 on any detected mismatch (in sensor data coming from drone 410) and the digital twin. Drone 410 may perform additional measurements at 445, and send updated measurements 450 to TOS 400. TOS 400 may, at 455, update the digital twin with the updated measurements 450 received from drone 410. According to an example embodiment, initially, the digital twin may have wrong information on radio network performance in an area. Thus in certain example embodiments, it may be possible to detect the mismatch and correct it. As a result, the digital twin may have correct information and the correct information may be used to control the movement of equipment in the harbor with keeping the promise of URLLC and avoiding interruptions. For example, due to updated information, a certain route for moving cargo handling equipment may be favored from another route as in that way URLLC promise may be kept. In one embodiment the alarm on detected mismatch will initiate the patrol command for make updating of the digital twin data to occur.

At 460, the updated digital twin may be sent to TLS 405, and forwarded at 465 from TLS 405 to drone 410. After receipt of the updated digital twin, drone 410 may, at 470, continue patrolling the area.

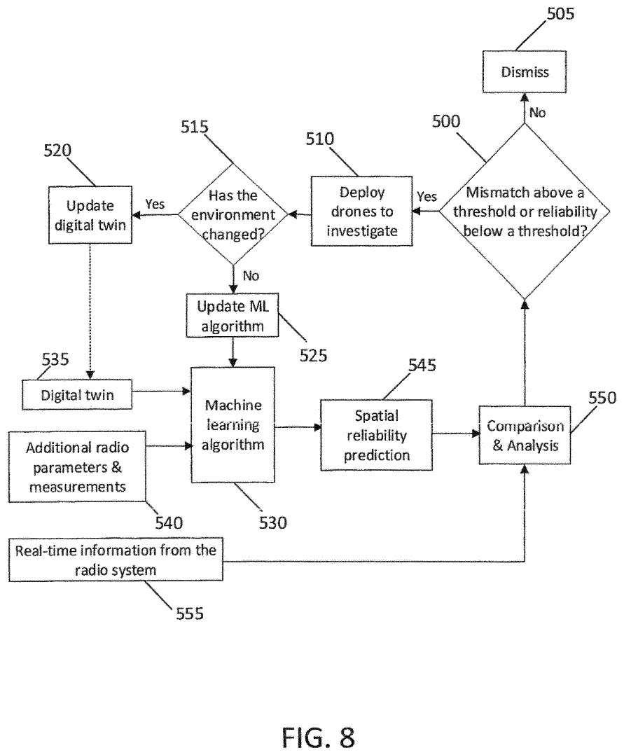

FIG. 8 illustrates a radio-based procedure for updating the digital twin, according to an example embodiment. The procedure may take place in various physical environments including, for example, a harbor environment, and the functions illustrated in FIG. 8 may be performed by the central controlling unit. As illustrated in FIG. 8, it may be possible to use information from the radio system to determine the areas that might be outdated or inaccurate in the digital twin, and should thereby be investigated by a drone for possible changes. In an example embodiment, the radio-based triggering may rely on information about the digital twin and potentially some additional parameters or measurements, which may be fed to a pre-trained ML algorithm. The digital twin may provide information about the local topography and potential blockages, which may directly affect the path loss experienced by the radio signal. Providing such information to a properly trained ML algorithm may provide a prediction about the expected radio reliability in the corresponding location.

As illustrated in FIG. 8, at 500, the drone may detect a mismatch and inform central control unit about the mismatch. The mismatch may occur when a difference between modeled parameters of a digital twin and measured parameters obtained from the actual environment is above a threshold. Alternatively, a mismatch may occur when the URLLC-level reliability observed at the environment compared to the reliability predicted based on the digital twin is below a threshold. If no mismatch is determined, the procedure may be dismissed at 505. However, if a mismatch is determined, at 510, the central control unit may deploy drones to investigate the area experiencing the mismatch. At 515, the central control unit may determine if the environment has changed. If so, at 520, the digital twin may be updated with updated measurements obtained by the drone as a result of the changed environment.

If the environment has not changed, the central control unit may, at 525, update the ML algorithm. According to an example embodiment, the ML may be updated with any information including, for example, information on no changes may give additional information on a situation and confidence on the situation. At 530, the updated ML algorithm may be implemented. In addition, at 530, the ML algorithm may be implemented with the updated digital twin 535 and additional radio parameters and measurements 540 obtained by the drone. With the digital twin 535 and additional radio parameters and measurements 540, spatial reliability may be predicted at 545. At 550, the central control unit may perform a comparison and analysis of the prediction, which may take into account real-time information from the radio system 555. After performing the comparison and analysis, the procedure may return to 500 to determine if a mismatch is present.

According to an example embodiment, the digital twin may include, among other parameters, information on SINR and BLER. This information may be updated by TOS into TLS and the patrolling device as part of the digital twin. Thus, the updated values may be communicated as part of the signal illustrated in FIG. 7 as “updated digital twin.” In addition, the patrolling may spend more time in areas with low SINR or high BLER. This may increase the chances of predicting and preventing reliability failures as a result of a more detailed digital twin in the risky areas.

In certain example embodiments, initial SINR values to the digital twin may come from simulations. Further, updated values may come from drones and other patrolling equipment or normal cargo handling equipment having UEs on board. SINR may come via their measurements, and BLER may result from the monitoring of the communication success, carried out by TOS. In an example embodiment, presence of the risky areas may also be part of the digital twin, and therefore be marked as areas with more patrolling than elsewhere. As such, updated values may be communicated as part of the signal illustrated in FIG. 7 as “updated digital twin.”

According to an example embodiment, the identified changes may need to be larger than a threshold. Further, the threshold may vary depending on the parameter that is observed. For example, for a container position, the threshold may be in relation to how accurately container positions are needed by the cargo handling equipment. In an example embodiment, this may be 10 cm.

In an example embodiment, if the reliability predicted based on the digital twin significantly differs from the measured reliability, this may indicate that the ML algorithm is not receiving accurate input data. In an example embodiment, significantly different may correspond to if the difference is larger than a threshold. According to an example embodiment, the threshold may be defined based on estimating if the difference results in the targeted reliability level of URLLC going below the target value for reliability. Consequently, the digital twin may be outdated.

If the mismatch is sufficiently large, a drone may be sent to investigate the area in question. According to an example embodiment, the mismatch may be sufficiently large if the difference is larger than a threshold. In an example embodiment, the threshold may be defined based on estimating if the difference results in the targeted reliability level of URLLC going below the target value for reliability. In another example embodiment, if there are not enough drones available, it may be possible to prioritize the locations with worse reliability to be updated first into the digital twin. Such prioritization may suggest that areas with worse radio reliability are investigated more often, and consequently the digital twin may be more accurate there. This may be crucial in order to use the digital twin for radio optimization in such areas, as there may be very little margin for errors due to an inaccurate digital twin.

According to an example embodiment, if upon investigating a location for which the ML algorithm gave a warning it is found that the digital twin is still accurate, the ML algorithm may be adjusted accordingly to reduce the probability of such false alarms in the future. In other words, according to an example embodiment, the radio-based update triggering may also yield real-time training data for the underlying ML algorithm as a by-product. In an example embodiment, to make the real-time ML training more effective, it may be possible to combine data from different sites if the same operator is responsible for the digital twin in several harbors.

In an example embodiment, if a mismatch between the real environment and the digital twin is identified, the latter may be updated by the most suitable means, which may include, for example, sending a measuring equipment such as a drone to perform a measurement. If an additional object in the real environment is recognized that needs to be added to the digital twin, the drone or other equipment may measure its dimension, read any bar codes visible, or sense any radio frequency identification (RFID) tags or other electronic fingerprints. In an alternative example embodiment, the drone may be added to be part of the digital twin, and its appearance in the digital twin may change based on the location and/or altitude. If not enough information can be gathered, the drone or other equipment may signal this and ask for a human to visit the site to gather the missing information. After all necessary information has been gathered, the information may be fed into the digital twin.

According to an example embodiment, if an object is recognized missing, corresponding information may need to be removed from the digital twin. At the same time, an alarm may need to be made to signal the need to find out why and how the object is missing. In another example embodiment, the object(s) in the digital twin may also have some additional data about the missing item. For example, when a tractor or lift start to move the object, it may be interpreted that the object does not need any more information to exist in the digital twin since the object has been moved by using the right lift or truck, and the movement is arranged according to schedule or to the right place.

To facilitate proactive actions (e.g., sending a drone, which may be different than most of the drones described herein, to function as a relay to remove risk for bad coverage of the radio signal) for enhanced URLLC operation, certain example embodiments may be able to identify a possible mismatch between the digital twin and the real environment also in areas where there are not recent observed radio performance measurements available, but where a specific UE (harbor machine, harbor worker, etc.) might be heading. Further, drones or other moving measurement platforms may be configured and scheduled by the central control unit to transmit/receive URLLC type traffic to enable estimation of real observed URLLC link performance in these areas. The observed URLLC performance metrics may be stored in the form of a location-dependent map of the observed reference quality of URLLC connectivity as part of the digital twin. This may allow for the analysis of the level of mismatch between the observed and predicted reliability at any location of the operation area at any given time.

In an example embodiment, the area where URLLC is needed may depend on the use cases. For example, in the case of an automated port, URLLC may be needed everywhere with autonomous cargo handling equipment.

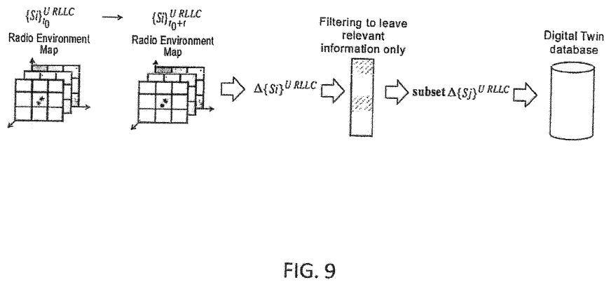

FIG. 9 illustrates a procedure for communicating with a digital twin, according to an example embodiment. As illustrated in FIG. 9, a radio environment map (REM) with a state S may be generated. The state S may be specific for URLLC. As also illustrated in FIG. 9, the state of the map may change during time window Δt, and the change of the state may be represented as Δ{Sᵢ}^{URLLC}. In addition, only a subset Δ{Sⱼ}^{URLLC}, j<i of the changes may be relevant for the operation, and it may be possible to communicate the changes to the digital twin via an interface or digital twin maintenance function.

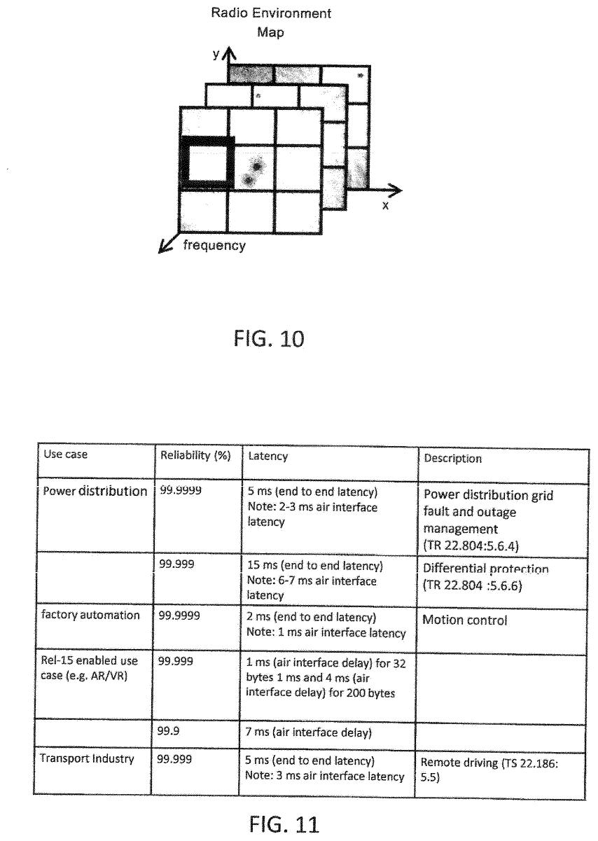

FIG. 10 illustrates a radio environment map, according to an example embodiment. In an example embodiment, REM may be a spatial database d(x,y,z), where the data d is stored in 3D tiles corresponding to coordinates x, y, and z. The grid point resolution illustrated as the highlighted box in FIG. 10 may depend on the environment and also practical constraints such as the maximum size of the database. Further, the grid tiles may not have to be the same size, but the resolution may be different on different areas (e.g., 10 m on one area and 1 m on the area where there are high gradients in the radio map). Furthermore, the resolution may be different between different axis. Any location-dependent data that is maintained as part of the DT, have to presented with finite precision/granularity in space. The radio environment map (REM) presents an example of the geolocation information content of the spatial database, that can be maintained as part of the DT, and where data is stored with finite grid resolution in 3D space. In one example embodiment the measurement/sensing data acquired from the movable devices (e.g. UAVs) may be associated initially with location data (e.g. GPS coordinates). Quantization in space and mapping to 3D tiles of the database can take place as part of the DT maintenance/update procedure.

In an example embodiment, the data may be multi-dimensional data and may contain radio-related information associated to that grid point. For example, RSRP of own and neighboring cells, RSRQ, SINR, SNR, LOS/NLOS between two or more grid points etc. Further, some changes in the REM may be relevant to the URLLC service. The main URLLC service requirements may include latency and reliability. In certain example embodiments, they may be different depending on the case. The network operator, customer or, for example, network slice owner may configure the exact requirements for the service (e.g., digital harbour operation). Examples are shown in the table illustrated in FIG. 11.

According to an example embodiment, when the state of the REM changes (often due to changes in the physical world, for example, steel containers are moved), the changes may be checked against the URLLC service requirements for example, for expected reliability and latency affected by the change. If the change is relevant for the service/application in question, those changes may be signalled to the digital twin database, which may be updated accordingly.

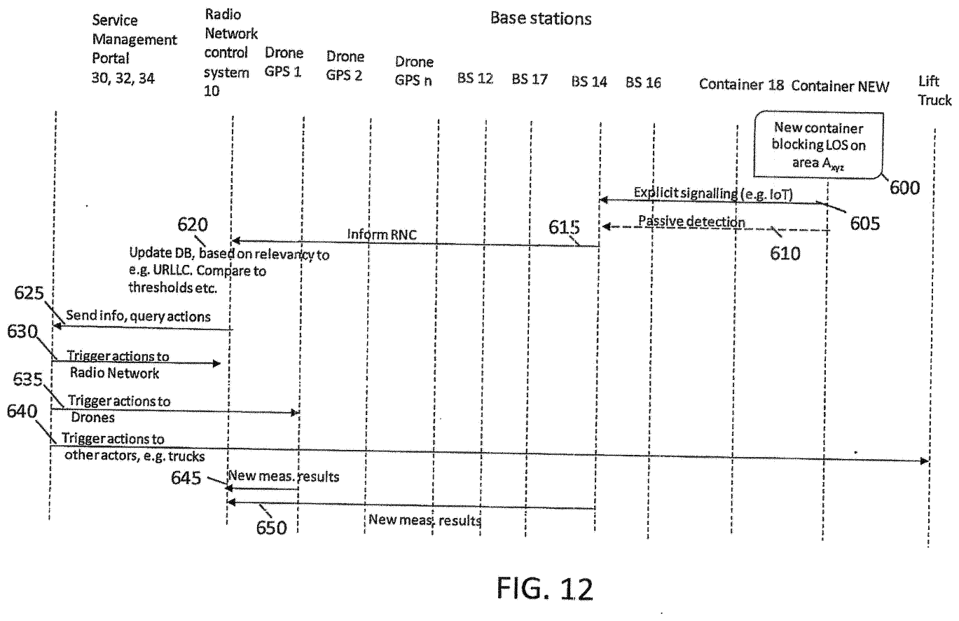

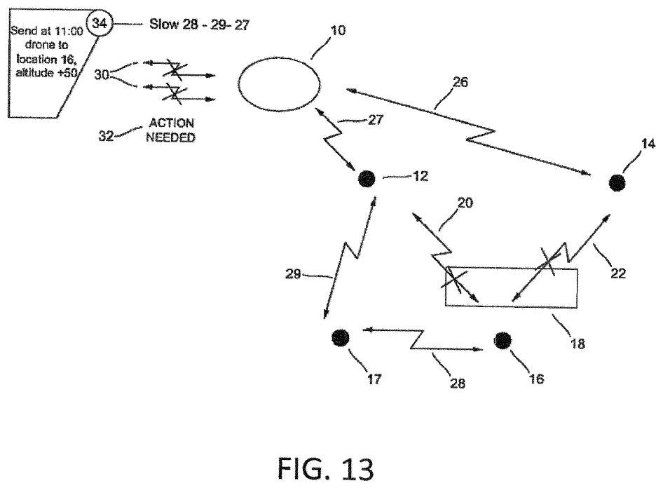

FIG. 12 illustrates a signalling flow, according to an example embodiment. Further, FIG. 13 illustrates a network system implementing the signal flow illustrated in FIG. 12. As illustrated in FIG. 13, the network system may include a service management portal 30, 32, 34 in communication with a radio network control system 10. The network system may also include BSs 12, 14, 16, 17 which may be in communication with each other as well as the radio network control system 10 via communication signals 26, 27, 28, 29. As illustrated in FIG. 13, the service management portal may receive indications 34 of poor radio performance or slow radio communications between BSs 12, 14, 16, 17 throughout the network, and receive knowledge 30 regarding communications that are blocked or interfered for example by an object such as a container. For example, as illustrated in FIG. 13, a container 18 may cause interference or blockage of radio signals 20, 22. To address this issue, the service management portal may initiate or trigger actions needed 32 in the network to address radio communication impedance. In an example embodiment, the action may include sending a drone to the location that is experiencing poor radio communication, such as for example, to BS 16.

FIG. 12 illustrates a signalling flow when a new container triggers a worse signal in one area, and the digital twin may be updated and actions created because of the new container. The signal flow may begin, initially, at 600, where a new container is added and blocks LOS on a particular area A_{xyz} of an environment such as a harbour environment. At 605, the new container may send explicit signalling (e.g., IoT) to BS 14. If the container is not equipped with radio, explicit signalling by radio is not possible, but the new blocking container may be detected without explicit signalling by “passive detection” at 610. This can be done for example by one or more of the base stations or UEs which detect high increase of the pathloss in the radio link on that area, or disappearance of the LOS component in the measured channel response, or a camera view of the area by making a comparison between past and current objects in the view. Further, at 610, passive detection information may be sent to BS 14. In response to the explicit signalling and passive detection, BS 14 may inform radio network control (RNC) system 10 about the detection and signalling at 615. At 620, RNC system 10 may, with the information received at 615, update the database based on relevancy to, for example, URLLC. In an example embodiment, the URLLC or the like may be one possible performance constraint. In addition, RNC system 10 may compare thresholds. At 625, RNC system 10 may send information and query actions to service management portal 30, 32, 34.

At 630, service management portal 30, 32, 34 may trigger actions to RNC system 10, and may also at 635, trigger actions to drone GPS 1. In addition, at 640, service management portal 30, 32, and 34 may trigger actions to other actors including, for example, trucks. At 645, drone GPS 1 may send new measurement results to RNC system 10, and at 650, BS 14 may send new measurement results to RNC system 10. According to an example embodiment, the drone GPS 1 may depict that there is a location one with GPS coordinates where the drone should be routed. In addition, drone GPS 2 may depict that in other situations, the drone may be routed to another location two defined by the GPS coordinates. Further, there may be other locations and locations one and two may be changed, when the drone or embedded apparatus functionalities in predetermined location is not working properly, for example.

In certain example embodiments, the service management portal 30, 32, 34 may trigger various actions. For example, a user interface (UI) may display an error that has occurred. In such a situation, although the operator may notice the error, no action is required by the operator other than observing communications between BS 16 and BS 12, as well as between BS 16 and BS 14 are not working properly. Often the problematic communication between the base station between UEs/sensors and BSs as some added stuff container or the like therebetween may lower the quality of the performance. If action is needed, service management portal 32 may be active, and the operator may be suggested a potential solution to the problem by showing in 34, “send at 11:00 drone to location 16 in altitude +50 to fix the situation.” The operator may then accept or deny the proposed action, or the operator may further modify the route of the drone and may obtain, for example, a digital map view of the area to see the most appropriate route to the drone to obtain the situation solved.

In an alternative method, the activation of the UI elements may be triggered when the truck or lift is approaching the area with performance constraint communication between radio elements. The activation of the UI elements may also be triggered when the truck or lift has a need for moving the container in the area. The operator may then obtain the information in the display and select by, for example, touching the action needed. In an example embodiment, the “slow 28-29-27” illustrates the connection speed which may, in this case, be too slow and may trigger the error message immediately or later.

According an example embodiment, the UI may change after selecting the drone, for example, to solve the problem, and the UI may display the place where the drone should fly. In addition, the operator may have the possibility of selecting the action to send the drone to fix the problem. The operator may also be shown the drone on the digital map during the progress of flying. In addition, the operator may obtain the indication that the situation of the error has been solved by seeing that the error is no longer seen as an error on the display. The operator may change the route on the display by giving commands using an electronic mouse device and double clicking the display of the digital map on the area. If the planned route is not good enough to change the error status, a notification may be displayed to the operator indicating another possible path to be selected in order to find the right place for omitting the error.

In an example embodiment, the display of the UI may develop based on the results received for the drone, for example, when trying to find the possible place for the drone to remove the error. Further, when in the place where the error is solved, the drone may continue to be placed during loading and/or movement of the container, and it may displayed on the display as one object. Further, after the connection starts to work according to the needs, the drone may return to its nest and may be ready for charging and getting ready for the next possible mission.

According to an example embodiment, the UI may have several functionalities. For example, the UI may provide means for the harbor operator to interact with the digital twin (DT). In this regard, the harbor operator may manage the content of the DT through the UI, for example, to present system state information in (close to) real-time during operation (i.e., system monitoring), based on the user-specified settings according to user selections on the UI. The content may include notifications and visualization of the areas with identified mismatches between the real-world physical layout of the harbor operation area and its model in the DT. The content may further include notifications and visualization of the areas with identified mismatches between the real-world measured radio performance of the harbor operation area and the DT-based estimated radio performance.

In an example embodiment, the terminal operator may use the UI to observe and validate the functionality of the system. For example, the UI may be used to observe and validate in terms of correct operation of the mismatch detection and correction procedures. Further, in an example embodiment, the UI may be configured to highlight the identified areas of the harbor yard where the set radio performance requirements are not met (e.g., the URLLC reliability and/or latency target thresholds are exceeded or about to be exceeded). In another example embodiment, the UI may be configured to highlight the identified areas of the harbor yard where the model of the physical layout of the harbor does not match with the real-world physical layout.

According to a further example embodiment the UI may be configured to show information for the identified mismatch, including, for example, a unique identification number, coordinates, time of records of the associated information in the DT and the real-world counterpart, or a measure of the level of the mismatch. In certain example embodiments, the measure of the level of the mismatch may include, for example, the volume of the rea in case of physical world mismatch, and/or the difference in the latency estimates in case of radio world mismatch.

In a further example embodiment, the UI may be configured to visualize how counter measures are activated. In certain example embodiments, the counter measures may include an operation of assisting UAVs for i) repeated patrolling, ii) triggered mismatch detection, and/or iii) mobile relaying.

According to another example embodiment, the UI may be configured to show video feeds from UAVs and/or other mobile measurement platforms measuring the physical world in a specified area, with visualization of the real-time measurement data. In certain example embodiments, the real-time measurement data may include information on identified objects including, for example, object type, ID, position, size, etc.

In another example embodiment, the UI may be configured to visualize the impact of the counter measures including, for example in terms of updated radio performance metrics. In a further example embodiment, the UI may be configured to visualize operations of relaying UAVs triggered to enhance the radio connectivity (e.g., URLLC critical metrics) in the identified problem areas, with visualization of the real-time measurement data. The real-time measurement data may include, for example, information on the effective latency with relaying UAV based on measurements from assisting UAVs, other mobile measurement platforms, and/or harbor machines. UAVs/drones may be deployed in different ways and in different roles according to the embodiment. UAVs may be utilized as mobile relays and/or as aerial BSs to provide the connectivity for the IoT devices. In example embodiment there may be simultaneously UAV(s) deployed as aerial BS(s) while some other UAV(s) operate as mobile relay(s). In one further embodiment there can be UAVs deployed as aerial UEs performing for example measurement/sensing flight missions. The exact deployment configuration may vary depending on the operation area to be covered and the amount of fixed networking infrastructure available.

The connection between a UAV/drone and TLS or TOS may be i) through fixed (terrestrial) BS(s), ii) through aerial BS(s) or iii) through both type of BSs, depending on the case (e.g. location of a given drone and available fixed and aerial BSs in the proximity to enable the connection). In one example embodiment one or more of the one of the reliability or latency values may be measured from two or more aerial links and then the total reliability or latency values are a sum of these values. Thus to be in acceptable level the reliability and latency value in one link may be even better than the values mentioned in FIG. 10. In one further embodiment the aerial and fixed links between network elements are needed to be measured and used then as a sum to determine the reliability and latency values comparable to the acceptable values.

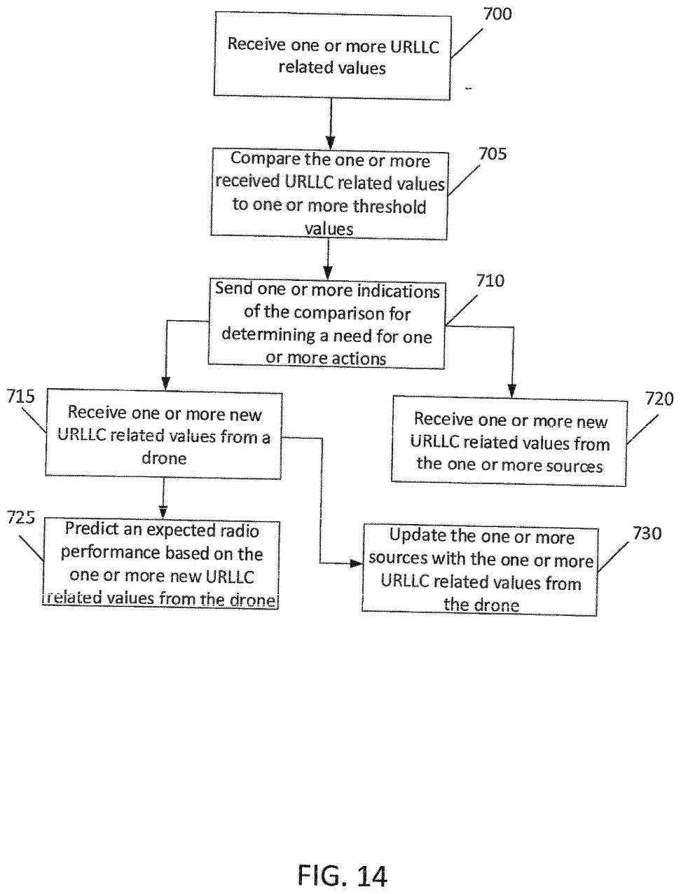

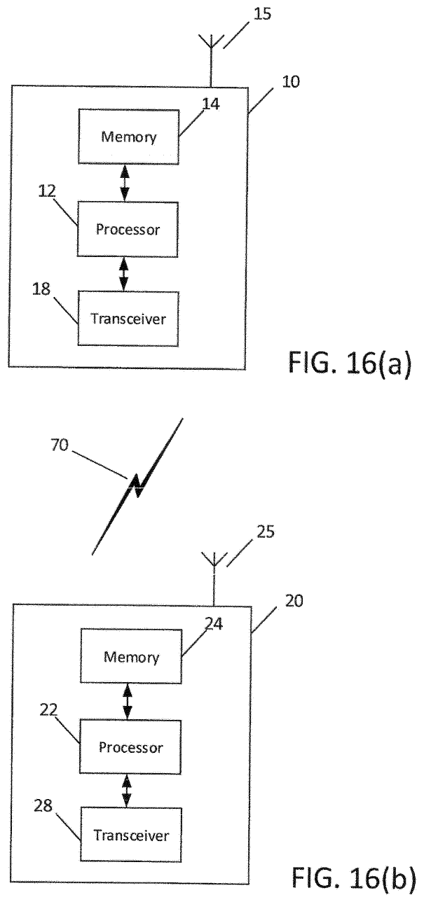

FIG. 14 illustrates a flow diagram of a method, according to an example embodiment. In an example embodiment, the flow diagram of FIG. 14 may be performed by a radio network control (RNC) system, for instance, similar to apparatus 10 illustrated in FIG. 16(a). According to an example embodiment, the method of FIG. 14 may include initially, at 700, receiving, by a radio network control system, one or more ultra-reliable low latency communication related values from one or more sources with geolocation information. The method may also include, at 705, comparing the one or more received ultra-reliable low latency communication related values to one or more threshold values of the one or more sources to determine presence of a mismatch. In addition, the method may include, at 710, sending one or more indications of the comparison of the ultra-reliable low latency communication related values and the one or more threshold values to a service management portal for determining a need for one or more actions.

The geolocation information may have received from the source, or geolocation information may have received from other system elements or functionalities which have received the geolocation information when the source has been brought to the location. In one embodiment the lift or truck may have sent the geolocation information to the digital twin, service management portal and/or system element or as well to TLS and TOS, when the source brought to the location, for example.

In FIG. 14, the method may also include, at 715, receiving, after the one or more actions have taken place, one or more new ultra-reliable low latency communication related values from a drone at a location corresponding to the geolocation information. The method may further include at 720, receiving, after the one or more actions have taken place, one or more new ultra-reliable low latency communication related values from the one or more sources. In addition, the method may include, at 725, predicting via machine learning, an expected radio performance at the location corresponding to the geolocation information based on the one or more new ultra-reliable low latency communication related values from the drone. Further, the method may include, at 730, updating the one or more sources with the one or more new ultra-reliable low latency communication related values from the drone.

According to an example embodiment, the one or more sources may include Internet of things devices, containers, truck lifts, base stations, or a digital twin. In another example embodiment, the mismatch may be a result of a dynamically changing environment. According to a further example embodiment, the radio network control system may include a user interface. The RNC may, via the user interface, interact with the digital twin, service management portal or system element, and observe and validate functionalities of the RNC system. In one embodiment the digital twin, service management portal and/or system element as well TLS and TOS may be integrated with RNC.

According to a further example embodiment, the radio network control system may include a user interface. The RNC may, via the user interface, interact with the digital twin, service management portal or system element, and observe and validate functionalities of the RNC system. In one embodiment the digital twin, service management portal and/or system element as well TLS and TOS or their functionalities may be integrated with RNC. In one embodiment the system element and/or service management portal may comprise digital twin, RNC and/or TLS, and/or TOS or at least communication interfaces between them. They or their functionality are implemented by a computer, or two or more computers. The functionality determines communication between one or more mobile devices and the base station to be monitored based on at least partially an Internet Protocol, IP, address of the mobile device. The functionality executes communications protocol between the mobile device and the base station. The functionality determines for example one or more lost or non-acceptable responses from the communication between one or more mobile devices and base station and causes generation or triggering of a maintenance action to the communication between one or more mobile devices and base station and a communication between at least one of different functionalities of the digital twin, service management portal and/or system element as well TLS and TOS for one or more recovery methods for the mobile device. In the embodiment as a result the mobile device may communicate with base station in desired manner.

The functionalities may be implemented by dedicated physical resources or shared physical resources. The physical resources may comprise one or more processor cores, memory devices and computers. The shared physical resources may comprise at least partially virtualized physical resources that may be configurable to one or more functionalities as needed. In an example a functionality or its part may be a cloud service. In contrast to the shared physical resources, the dedicated physical resources comprise hardware units that are configured to be used by at least a single functionality.

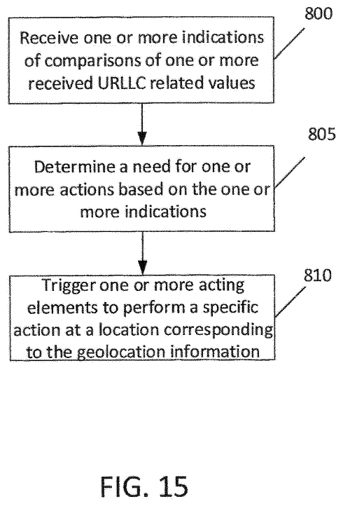

FIG. 15 illustrates a flow diagram of another method, according to an example embodiment. In an example embodiment, the method of FIG. 15 may be performed by a service management portal. For instance, in an example embodiment, the method of FIG. 15 may be performed by a service management portal similar to apparatus 20 illustrated in FIG. 16(b).

According to an example embodiment, the method may include initially, at 800, receiving, by a service management portal, one or more indications of comparisons of one or more received ultra-reliable low latency communication related values with geolocation information to one or more threshold values of one or more sources. The method may also include, at 805, determining a need for one or more actions based on the one or more indications. The method may further include, at 810, in response to the determination, triggering one or more acting elements to perform a specific action at a location corresponding to the geolocation information to optimize radio performance at the location.

In an example embodiment, the one or more acting elements may include a radio network, a drone, or mechanically operable objects. In another example embodiment, the one or more indications may include a mismatch indication indicating a difference between the one or more received ultra-reliable low latency communication related values and one or more threshold values of the one or more sources. According to a further example embodiment, the mismatch may be a result of a dynamically changing environment. According to another example embodiment, the specific action may include measuring surroundings for placement of physical objects, classifying objects based on their materials, shapes or colors, classifying objects based on attached tags, measuring over radio spectrum, identifying radio activity on different radio wavelengths, or identifying positions of radio transmitters.

FIG. 16(a) illustrates an example apparatus 10 according to an example embodiment. In an embodiment, apparatus 10 may be a node or element in a communications network or associated with such a network, such as a UE, mobile equipment (ME), mobile station, mobile device, stationary device, IoT device, RNC system, drone, or other device. As described herein, UE may alternatively be referred to as, for example, a mobile station, mobile equipment, mobile unit, mobile device, user device, subscriber station, wireless terminal, tablet, smart phone, IoT device, sensor or NB-IoT device, or the like. As one example, apparatus 10 may be implemented in, for instance, a wireless handheld device, a wireless plug-in accessory, or the like.

In some example embodiments, apparatus 10 may include one or more processors, one or more computer-readable storage medium (for example, memory, storage, or the like), one or more radio access components (for example, a modem, a transceiver, or the like), and/or a user interface. In some embodiments, apparatus 10 may be configured to operate using one or more radio access technologies, such as GSM, LTE, LTE-A, NR, 5G, WLAN, WiFi, NB-IoT, Bluetooth, NFC, MulteFire, and/or any other radio access technologies. It should be noted that one of ordinary skill in the art would understand that apparatus 10 may include components or features not shown in FIG. 16(a).

As illustrated in the example of FIG. 16(a), apparatus 10 may include or be coupled to a processor 12 for processing information and executing instructions or operations. Processor 12 may be any type of general or specific purpose processor. In fact, processor 12 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples.

While a single processor 12 is shown in FIG. 16(a), multiple processors may be utilized according to other embodiments. For example, it should be understood that, in certain example embodiments, apparatus 10 may include two or more processors that may form a multiprocessor system (e.g., in this case processor 12 may represent a multiprocessor) that may support multiprocessing. According to certain example embodiments, the multiprocessor system may be tightly coupled or loosely coupled (e.g., to form a computer cluster).

Processor 12 may perform functions associated with the operation of apparatus 10 including, as some examples, precoding of antenna gain/phase parameters, encoding and decoding of individual bits forming a communication message, formatting of information, and overall control of the apparatus 10, including processes related to management of communication resources.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 14 can be comprised of any combination of random access memory (RAM), read only memory (ROM), static storage such as a magnetic or optical disk, hard disk drive (HDD), or any other type of non-transitory machine or computer readable media. The instructions stored in memory 14 may include program instructions or computer program code that, when executed by processor 12, enable the apparatus 10 to perform tasks as described herein.

In an embodiment, apparatus 10 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 12 and/or apparatus 10.

In some embodiments, apparatus 10 may also include or be coupled to one or more antennas 18 for receiving a downlink signal and for transmitting via an uplink from apparatus 10. Apparatus 10 may further include a transceiver 18 configured to transmit and receive information. The transceiver 18 may also include a radio interface (e.g., a modem) coupled to the antenna 15. The radio interface may correspond to a plurality of radio access technologies including one or more of GSM, LTE, LTE-A, 5G, NR, WLAN, NB-IoT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDMA symbols, carried by a downlink or an uplink.

For instance, transceiver 18 may be configured to modulate information on to a carrier waveform for transmission by the antenna(s) 15 and demodulate information received via the antenna(s) 15 for further processing by other elements of apparatus 10. In other embodiments, transceiver 18 may be capable of transmitting and receiving signals or data directly. Additionally or alternatively, in some embodiments, apparatus 10 may include an input and/or output device (I/O device). In certain embodiments, apparatus 10 may further include a user interface, such as a graphical user interface or touchscreen.

In an embodiment, memory 14 stores software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software. According to an example embodiment, apparatus 10 may optionally be configured to communicate with apparatus 20 via a wireless or wired communications link 70 according to any radio access technology, such as NR.

According to certain example embodiments, processor 12 and memory 14 may be included in or may form a part of processing circuitry or control circuitry. In addition, in some embodiments, transceiver 18 may be included in or may form a part of transceiving circuitry.

As discussed above, according to certain example embodiments, apparatus 10 may be a UE, mobile device, mobile station, ME, IoT device and/or NB-IoT device, for example. According to certain embodiments, apparatus 10 may be controlled by memory 14 and processor 12 to perform the functions associated with example embodiments described herein. For example, in some embodiments, apparatus 10 may be configured to perform one or more of the processes depicted in any of the flow charts or signaling diagrams described herein, such as the flow diagrams illustrated in FIGS. 1-14.

For instance, in one embodiment, apparatus 10 may be controlled by memory 14 and processor 12 to receive, by a radio network control system, one or more reliability and latency constraint communication related values from one or more sources with geolocation information. Apparatus 10 may further be controlled by memory 14 and processor 12 to compare the one or more received reliability and latency constraint communication related values to one or more threshold values of the one or more sources to determine presence of a mismatch. Apparatus 10 may also be controlled by memory 14 and processor 12 to send one or more indications of the comparison of the reliability and latency constraint communication related values and the one or more threshold values to a system element for determining a need for one or more actions.

Apparatus 10 may further be controlled by memory 14 and processor 12 to receive, after the one or more actions have taken place, one or more new reliability and latency constraint communication related values from a drone at a location corresponding to the geolocation information. Apparatus 10 may also be controlled by memory 14 and processor 12 to receive, after the one or more actions have taken place, one or more new reliability and latency constraint communication related values from the one or more sources. Apparatus 10 may further be controlled by memory 14 and processor 12 to predict via machine learning, an expected radio performance at the location corresponding to the geolocation information based on the one or more new reliability and latency constraint communication related values from the drone. Apparatus 10 may also be controlled by memory 14 and processor 12 to update the one or more sources with the one or more new reliability and latency constraint communication related values from the drone. The apparatus 10 may further be controlled by memory 14 and processor 12 to, via a user interface, interact with the digital twin, and observe and validate functionalities of the apparatus.

FIG. 16(b) illustrates an example of an apparatus 20 according to an example embodiment. In an example embodiment, apparatus 20 may be a node, host, or server in a communication network or serving such a network. For example, apparatus 20 may be a service management portal, satellite, base station, a Node B, an evolved Node B (eNB), 5G Node B or access point, next generation Node B (NG-NB or gNB), and/or WLAN access point, associated with a radio access network (RAN), such as an LTE network, 5G or NR. In certain example embodiments, apparatus 20 may be an eNB in LTE or gNB in 5G.

It should be understood that, in some example embodiments, apparatus 20 may be comprised of an edge cloud server as a distributed computing system where the server and the radio node may be stand-alone apparatuses communicating with each other via a radio path or via a wired connection, or they may be located in a same entity communicating via a wired connection. For instance, in certain example embodiments where apparatus 20 represents a gNB, it may be configured in a central unit (CU) and distributed unit (DU) architecture that divides the gNB functionality. In such an architecture, the CU may be a logical node that includes gNB functions such as transfer of user data, mobility control, radio access network sharing, positioning, and/or session management, etc. The CU may control the operation of DU(s) over a front-haul interface. The DU may be a logical node that includes a subset of the gNB functions, depending on the functional split option. It should be noted that one of ordinary skill in the art would understand that apparatus 20 may include components or features not shown in FIG. 16(b).

As illustrated in the example of FIG. 16(b), apparatus 20 may include a processor 22 for processing information and executing instructions or operations. Processor 22 may be any type of general or specific purpose processor. For example, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 22 is shown in FIG. 16(b), multiple processors may be utilized according to other embodiments. For example, it should be understood that, in certain embodiments, apparatus 20 may include two or more processors that may form a multiprocessor system (e.g., in this case processor 22 may represent a multiprocessor) that may support multiprocessing. In certain embodiments, the multiprocessor system may be tightly coupled or loosely coupled (e.g., to form a computer cluster).

According to certain example embodiments, processor 22 may perform functions associated with the operation of apparatus 20, which may include, for example, precoding of antenna gain/phase parameters, encoding and decoding of individual bits forming a communication message, formatting of information, and overall control of the apparatus 20, including processes related to management of communication resources.

Apparatus 20 may further include or be coupled to a memory 24 (internal or external), which may be coupled to processor 22, for storing information and instructions that may be executed by processor 22. Memory 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 24 can be comprised of any combination of random access memory (RAM), read only memory (ROM), static storage such as a magnetic or optical disk, hard disk drive (HDD), or any other type of non-transitory machine or computer readable media. The instructions stored in memory 24 may include program instructions or computer program code that, when executed by processor 22, enable the apparatus 20 to perform tasks as described herein.

In an embodiment, apparatus 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 22 and/or apparatus 20.

In certain example embodiments, apparatus 20 may also include or be coupled to one or more antennas 25 for receiving signals and/or data and for transmitting signals and/or data from apparatus 20. Apparatus 20 may further include or be coupled to a transceiver 28 configured to transmit and receive information. The transceiver 28 may include, for example, a plurality of radio interfaces that may be coupled to the antenna(s) 25. The radio interfaces may correspond to a plurality of radio access technologies including one or more of GSM, NB-IoT, LTE, 5G, WLAN, Bluetooth, BT-LE, NFC, radio frequency identifier (RFID), ultrawideband (UWB), MulteFire, and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (for example, via an uplink).

As such, transceiver 28 may be configured to modulate information on to a carrier waveform for transmission by the antenna(s) 25 and demodulate information received via the antenna(s) 25 for further processing by other elements of apparatus 20. In other embodiments, transceiver 28 may be capable of transmitting and receiving signals or data directly. Additionally or alternatively, in some embodiments, apparatus 20 may include an input and/or output device (I/O device).

In an embodiment, memory 24 may store software modules that provide functionality when executed by processor 22. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software.

According to some embodiments, processor 22 and memory 24 may be included in or may form a part of processing circuitry or control circuitry. In addition, in some embodiments, transceiver 28 may be included in or may form a part of transceiving circuitry.

As used herein, the term “circuitry” may refer to hardware-only circuitry implementations (e.g., analog and/or digital circuitry), combinations of hardware circuits and software, combinations of analog and/or digital hardware circuits with software/firmware, any portions of hardware processor(s) with software (including digital signal processors) that work together to case an apparatus (e.g., apparatus 20) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor (or multiple processors), or portion of a hardware circuit or processor, and its accompanying software and/or firmware. The term circuitry may also cover, for example, a baseband integrated circuit in a server, cellular network node or device, or other computing or network device.

As introduced above, in certain example embodiments, apparatus 20 may be a network node or RAN node, such as a base station, access point, Node B, eNB, gNB, WLAN access point, or the like. In another example embodiment, apparatus 20 may be an LFM. According to certain embodiments, apparatus 20 may be controlled by memory 24 and processor 22 to perform the functions associated with any of the embodiments described herein, such as the flow or signaling diagrams illustrated in FIGS. 1-13 and 15.

For instance, in one embodiment, apparatus 20 may be controlled by memory 24 and processor 22 to receive, by a service management portal, one or more indications of comparisons of one or more received reliability and latency constraint communication related values with geolocation information to one or more threshold values of one or more sources. Apparatus 20 may also be controlled by memory 24 and processor 22 to determine a need for one or more actions based on the one or more indications. Apparatus 20 may further be controlled by memory 24 and processor 22 to, in response to the determination, trigger one or more acting elements to perform a specific action at a location corresponding to the geolocation information to optimize radio performance at the location.

Certain example embodiments provide several technical improvements, enhancements, and/or advantages over conventional technologies, methods, and systems for reducing interruption time. Various example embodiments may, for example, provide a system that may constantly secure updated existence of accurate radio twin via sending drones or other moving measurement platforms to carry out signal measurements. Certain example embodiments may also provide a method and system to guarantee the accuracy of the digital twin despite any changes in the physical environment via detecting the mismatches and then correcting them. In an example embodiment, correcting the mismatch corresponds to updating new information to the digital twin so that it matches the measurements or other updated information that is provided. The digital twin may include information on the URLLC related latencies reachable in the model, and these values may be updated. Certain example embodiments may further provide a digital twin with information on the LOS/NLOS conditions for communication between different points of an operated area. Other example embodiments may increase the reliability of automation, and minimize costs associated with monitoring and controlling certain physical environments such as a harbor environment.

In addition, certain example embodiments may use a digital twin to optimize certain radio systems, and use the digital twin to provide information about the local topography and potential blockages in a physical environment. According to another example embodiment, it may be possible to obtain a properly trained ML algorithm that may provide a prediction about the expected radio reliability in a corresponding location of the environment.

In some example embodiments, the functionality of any of the methods, processes, signaling diagrams, algorithms or flow charts described herein may be implemented by software and/or computer program code or portions of code stored in memory or other computer readable or tangible media, and executed by a processor.

In some example embodiments, an apparatus may be included or be associated with at least one software application, module, unit or entity configured as arithmetic operation(s), or as a program or portions of it (including an added or updated software routine), executed by at least one operation processor. Programs, also called program products or computer programs, including software routines, applets and macros, may be stored in any apparatus-readable data storage medium and include program instructions to perform particular tasks.

A computer program product may comprise one or more computer-executable components which, when the program is run, are configured to carry out some of the various example embodiments described herein. The one or more computer-executable components may be at least one software code or portions of it. Modifications and configurations required for implementing functionality of an example embodiment may be performed as routine(s), which may be implemented as added or updated software routine(s). Software routine(s) may be downloaded into the apparatus.

As an example, software or a computer program code or portions of it may be in a source code form, object code form, or in some intermediate form, and it may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality may be performed by hardware or circuitry included in an apparatus, for example through the use of an application specific integrated circuit (ASIC), a programmable gate array (PGA), a field programmable gate array (FPGA), or any other combination of hardware and software. In yet another example embodiment, the functionality may be implemented as a signal, a non-tangible means that can be carried by an electromagnetic signal downloaded from the Internet or other network.

According to an example embodiment, an apparatus, such as a node, device, or a corresponding component, may be configured as circuitry, a computer or a microprocessor, such as single-chip computer element, or as a chipset, including at least a memory for providing storage capacity used for arithmetic operation and an operation processor for executing the arithmetic operation.

One having ordinary skill in the art will readily understand that the example embodiments as discussed above may be practiced with steps in a different order, and/or with hardware elements in configurations which are different than those which are disclosed. Therefore, although some embodiments have been described based upon these example preferred embodiments, it would be apparent to those of skill in the art that certain modifications, variations, and alternative constructions would be apparent, while remaining within the spirit and scope of example embodiments. In order to determine the metes and bounds of the example embodiments, therefore, reference should be made to the appended claims.

Partial Glossary

BS Base Station

eNB Enhanced Node B

gNB 5g or NR Base Station

IoT Internet of Things

LIDAR Light Detection and Ranging

LOS Line-of-Sight

LTE Long Term Evolution

ML Machine Learning

NLOS Non-Line-of-Sight

NR New Radio

RFID Radio Frequency Identification

SINR Signal-to-Interference-Plus-Noise Ratio

SNR Signal-to-Noise Ratio

TLS Terminal Logistics System

TOS Terminal Operating System

UAV Unmanned Aerial Vehicle

UE User Equipment

URLLC Ultra-Reliable Low Latency Communication

V2V Vehicle-to-Vehicle

V2X Vehicle-to-Everything

1.-29. (canceled)

30. An apparatus for operating a service management portal, said apparatus comprising:
at least one processor; and
at least one memory including computer program code,
the at least one memory and computer program code configured, with the at least one processor, to cause the apparatus at least to
receive one or more indications of comparisons of one or more received values representing a constraint on reliability and latency for communication with geolocation information to one or more threshold values of one or more sources of the communication;
determine a need for one or more actions to remedy a mismatch between the one or more received values representing the constraint on the reliability and the latency for the communication and the one or more threshold values, based on whether the one or more indications is larger than the one or more threshold values; and
in response to the determination, trigger one or more acting elements to perform a specific action at a location corresponding to the geolocation information to optimize radio performance at the location.

31. The apparatus according to claim 30, wherein the one or more acting elements further comprises a radio network, a drone, or one or more mechanically operable objects.

32. The apparatus according to claim 30, wherein the one or more indications further comprises a mismatch indication indicating a difference between the one or more received values representing a the constraint on the reliability and the latency for the communication and the one or more threshold values of the one or more sources of the communication.

33. The apparatus according to claim 30, wherein the mismatch is a result of a dynamically changing physical environment.

34. The apparatus according to claim 30, wherein the specific action further comprises a measuring of surroundings for placement of physical objects, a classifying of objects based on their materials, shapes or colors, a classifying of objects based on attached tags, a measuring over radio spectrum, an identifying of radio activity on different radio wavelengths, or an identifying of positions of radio transmitters.

35. An apparatus for operating a radio network control system, said apparatus comprising:
a circuitry configured to receive one or more values representing a constraint on reliability and latency for communication from one or more sources of communication with geolocation information, wherein
the circuitry is configured to compare the one or more received values representing the constraint on the reliability and the latency for the communication to one or more threshold values of the one or more sources of the communication to determine presence of a mismatch, and wherein
the circuitry is configured to send one or more indications of the comparison of the values representing the constraint on the reliability and the latency for the communication and the one or more threshold values to a system element for determining a need for one or more actions to remedy the mismatch based on whether the mismatch is larger than the one or more threshold values.

36. The apparatus according to claim 35, wherein the circuitry is further configured to:
receive after the one or more actions have taken place, one or more new values representing a constraint on reliability and latency for communication from a drone at a location corresponding to the geolocation information; and
receive after the one or more actions have taken place, one or more new values representing a constraint on reliability and latency for communication from the one or more sources of communication.

37. The apparatus according to claim 35, wherein the circuitry is further configured to predict via machine learning an expected radio performance at the location corresponding to the geolocation information based on the one or more new values representing a constraint on reliability and latency for communication from a drone.

38. The apparatus according to claim 35, wherein the circuitry is further configured to cause to update the one or more sources of communication with the one or more new values representing a constraint on reliability and latency for communication from a drone.

39. The apparatus according to claim 35, wherein the one or more sources of the communication comprises Internet of things devices, containers, truck lifts, base stations, or a digital twin.

40. The apparatus according to claim 35, wherein the mismatch is a result of a dynamically changing physical environment.

41. The apparatus according to claim 39,
wherein the radio network control system comprises a user interface, and
wherein when the one or more sources of communication comprises the digital twin, wherein the circuitry is further configured to interact, by the radio network control system, with the digital twin via the user interface, and observe and validate radio functionalities of the radio network control system.

42. An apparatus, comprising:
at least one processor; and
at least one memory including computer program code,
the at least one memory and computer program code configured, with the at least one processor, to cause the apparatus at least to
receive from a service management portal, a trigger to perform one or more actions at a location corresponding to a geolocation information to optimize radio performance at the location,
wherein the one or more actions are based on a determination of a need from one or more indications received of at least one comparison of at least one of received values representing a constraint on reliability and latency for communication with the geolocation information to one or more threshold values of one or more sources of the communication,
wherein the determination is based on whether the one or more indications is larger than the one or more threshold values, and
wherein the need is to remedy a mismatch between the one or more received values representing the constraint on the reliability and the latency for the communication and the one or more threshold values.

43. The apparatus of claim 42, wherein the at least one memory and computer program code are further configured, with the at least one processor, to cause the apparatus to carry out one or more actions including signal measurements in the location, and sending the measurements for updating a digital twin accordingly with new signal measurements.

44. The apparatus of claim 43, wherein the at least one memory and computer program code are further configured, with the at least one processor, to cause the apparatus to update respective data of objects comprising the geolocation information.

45. The apparatus of claim 42, wherein the location may be used as a waypoint or a destination.

46. The apparatus of claim 42, wherein the at least one memory and computer program code are further configured, with the at least one processor, to cause the apparatus to be added to be a part of a digital twin, and its appearance to be changed in the digital twin based on the location and/or an altitude.

47. The apparatus of claim 42, wherein the at least one memory and computer program code are further configured, with the at least one processor, to cause the apparatus to transmit/receive URLLC type traffic.

48. The apparatus of claim 42, wherein the apparatus is utilized as a mobile relay and/or an aerial base station.
